(19) United States
(12) Patent Application Publication
(10) Pub. No.: US 2011/0105669 A1
(43) Pub. Date: May 5, 2011

(54) PROCESS OF FORMING VULCANIZABLE ELASTOMERIC COMPOSITIONS USING ULTRA ACCELERATORS AND PRODUCTS FORMED THEREFROM

(75) Inventors: Frederick Ignatz-Hoover, Elyria, OH (US); Robert Arthur Francis, Park Orchards (AU); Robert Haring, Woluwe-Saint-Pierre (Brussels) (BE)

(73) Assignee: Flexsys America L.P., St. Louis, MO (US)

(21) Appl. No.: 12/609,634

(22) Filed: Oct. 30, 2009

(51) Int. Cl. C08K 3/26; C08L 83/00; C08K 3/34; C08K 3/22

(52) U.S. Cl. 524/425; 524/588; 524/445; 524/432

(57) ABSTRACT

A vulcanizable elastomeric composition and a method of forming said composition is presented. The method generally comprises the mixing of sulfur and an ultra-accelerator into a mixture of an elastomeric polymer matrix, fillers, and silane coupling agent during the silanization reaction step, prior to the occurrence of vulcanization. The addition of the ultra-accelerator, such as TBzTD, enhances the efficiency of the silanization reaction and forms at least one bond with the elastomeric polymer matrix. The silanization reaction step may comprise multiple mixing substeps in which the ultra-accelerator may be incorporated into the elastomeric composition.

### FIELD

This present disclosure relates generally to vulcanizable elastomeric compositions, to a process for their preparation, and to the use thereof. More specifically, the present disclosure relates to a process of forming silica-filled elastomeric compositions that are used to make such articles as tires, power belts, or the like.

### BACKGROUND

The incorporation of reinforcing fillers, such as silica, in vulcanizable elastomeric compositions affects the physical properties of the resulting vulcanized material, as well as the processability of said material. Significant problems have been encountered during the conventional processing of vulcanizable elastomeric compositions in regards to the dispersability of the silica filler in the elastomeric matrix. In order to overcome this problem, silane coupling agents have been used that can bond to the surface of the silica filler and couple with the elastomeric polymer.

Typically, the silane coupling agents used to disperse the silica filler in the elastomeric polymer matrix comprise a silicon atom covalently bound to three alkoxy functional groups and one alkyl chain having a sulfur-containing functional end-group. The alkoxy functional groups may react via a silanization reaction with silanol groups that are present on the surface of the silica filler during the initial mixing or process step in the formation of a vulcanizable elastomeric composition. This silanization reaction couples one end of the silane coupling agent to the surface of the silica, while alcohol is formed as a by-product. The creation of a layer of the silane coupling agent bound to and surrounding the surface of the silica filler enhances the dispersability of the filler in the elastomeric polymer matrix. In order to ensure homogeneous silanization and optimum dispersion of the resulting surface-treated silica filler, the coupling of the silane to the elastomeric polymer during this initial mixing is minimized in conventional processing. The sulfur-containing functional end-group is subsequently utilized in a second process step, namely, vulcanization, to couple with the elastomeric polymer matrix during the formation of a vulcanized or cross-linked elastomeric material.

The use of two separate process steps to first (1) silanize the surface of the silica and/or disperse the surface-treated silica into the elastomeric polymer matrix and second (2) to vulcanize or cross-link the elastomeric composition increases the overall process time required to form an article from the said composition. Efforts to reduce this overall process time has focused on ways to cause either the silanization reaction step (1) or the subsequent vulcanization reaction step (2) to occur more quickly. For example, the silanization of the silica filler may occur faster through the use of a higher temperature during the initial mixing or by increasing the amount of moisture present in the mixture in order to facilitate the formation of the alcoholic by-product during the silanization reaction. Accordingly, there exists a continual desire to form vulcanizable elastomeric compositions that will effectively reduce the overall process time necessary to make an article from said compositions while maintaining the necessary or desired performance characteristics.

### SUMMARY

The present disclosure provides a method of forming a vulcanizable elastomeric composition. One embodiment of the method, constructed in accordance with the teachings of the present disclosure, generally comprises the mixing of sulfur and an ultra-accelerator into a mixture of an elastomeric polymer matrix, silica filler, and silane coupling agent during the silanization reaction step, which precedes the occurrence of vulcanization. The addition of the ultra-accelerator enhances the efficiency of the silanization reaction and forms at least one bond with the elastomeric polymer matrix. The silanization reaction step may comprise multiple mixing substeps in which the ultra-accelerator can be incorporated into the elastomeric composition.

According to another aspect of the present disclosure a method of forming an elastomeric article for use as a tire is presented. This method generally comprises forming a vulcanizable elastomeric composition according to the method disclosed herein; followed by subjecting said vulcanizable elastomeric composition to a predetermined temperature and pressure to form the elastomeric article. The applied temperature and pressure causes the elastomeric polymer matrix to cross-link and to couple with the silane coupling agent bound to the silica filler.

Another objective of the present disclosure is to provide a vulcanizable elastomeric composition that comprises an elastomeric polymer matrix, a silica filler, a silane coupling agent, sulfur, and an ultra-accelerator where the silane coupling agent is coupled to the silica filler through the occurrence of a silanization reaction and the ultra-accelerator enhances the efficiency of said silanization reaction and forms at least one bond with the elastomeric polymer. The efficiency of the silanization reaction refers to the optimization of the surface area over which the silane coupling agent passivates the surface of the silica filler.

According to one aspect of the present disclosure, the silane coupling agent is defined as having one end-group capable of coupling to the surface of the silica filler and a second end-group capable of coupling with the elastomeric polymer matrix, the second end-group being one selected from the group of a mercapto, amino, vinyl, epoxy, and sulfur group. Preferably, the silane coupling agent is one selected from the group of bis(triethoxysilylpropyl)polysulfide and the 3-(triethoxysilyl)propanthiol reaction products with ethoxylated C13-alcohol.

According to another aspect of the present disclosure, the ultra-accelerator is one selected from the group of 1,6-bis(N,N-dibenzylthiocarbamoyldithio)-hexane (BDTCH), tetrabenzylthiuram disulfide (TBzTD), tetraisobutylthiuram disulfide (TiBTD), and mixtures thereof. In addition, the ultra-accelerator may further comprises at least a second accelerator selected as one from the group of zinc dibenzyldithiocarbamate (ZBEC), tetraethylthiuram disulfide (TETD), tetramethylthiuram disulfide (TMTD), tetramethylthiuram monosulfide (TMTM), tetraalkyl (C₁₂-C₁₄) thiuram disulfide (TATD), hexamethylene-1,6-bis(thiosulfate) disodium salt dihydrate (HTS), diphenyl guanidine (DPG), and mixtures thereof. Preferably, the ultra-accelerator is present in an amount in the range of about 0.02 to 2.0 parts of rubber (phr), with the range of about 0.05 to 1.0 phr being preferred.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1A is a schematic representation of a method for forming a vulcanized elastomeric article according to one embodiment of the present disclosure highlighting a silanization step with multiple mixing substeps followed by a vulcanization step;

FIG. 1B is a schematic representation of the multiple mixing substeps in the silanization step for the method of FIG. 1A according to another aspect of the present disclosure;

FIG. 2 is a bar chart of the average Payne effect measured for elastomeric materials vulcanized from elastomeric compositions prepared according to the teachings of the present disclosure;

FIG. 3 is a bar chart of the delta Mooney viscosity measured at the end of day 1 and day 3 for elastomeric compositions prepared according to the teachings of the present disclosure;

FIG. 4 is a graphical representation of the Payne effect plotted as a function of the delta Mooney viscosity measured after day 1 for elastomeric compositions of FIG. 2;

FIG. 5 is a graphical representation of the Payne effect plotted as a function of the delta Mooney viscosity measured after day 3 for elastomeric compositions of FIG. 2;

FIG. 6 is a bar chart of the storage modulus (G″) measured for vulcanized elastomeric materials derived from elastomeric compositions prepared according to the teachings of the present disclosure;

FIG. 7 is a bar chart of the Pico Abrasion Index value measured for vulcanized elastomeric materials derived from elastomeric compositions prepared according to the teachings of the present disclosure;

FIG. 8 is a graphical representation of the Pico Abrasion Index values plotted as a function of the Payne effect measured for the elastomeric materials of FIG. 7;

FIG. 9 is a graphical representation of the Pico Abrasion Index values plotted as a function of the Loss Factor (tan d) measured for the elastomeric materials of FIG. 7 at low strain (1%);

FIG. 10 is a graphical representation of the Pico Abrasion Index values plotted as a function of the Loss Factor (tan d) measured for the elastomeric materials of FIG. 7 at moderate strain (5%);

FIG. 11 is a graphical representation of the Pico Abrasion Index values plotted as a function of the Loss Factor (tan d) measured for the elastomeric materials of FIG. 7 at relatively high strain (10%);

FIG. 12 is a graphical representation of the Pico Abrasion Index values plotted as a function of the Loss Factor (tan d) measured for the elastomeric materials of FIG. 7 at high strain (25%);

FIG. 13A is a graphical representation of the loss factor (tan d) plotted as a function of the applied strain (%) for various elastomeric materials prepared according to the teachings of the present disclosure;

FIG. 13B is a graphical representation of the loss modulus plotted as a function of the applied strain (%) for various elastomeric materials of FIG. 13A;

FIG. 14A is a bar chart for the Payne effect measured for various elastomeric compositions prepared according to the teachings of the present disclosure using process parameters of Run 3-01;

FIG. 14B is a bar chart for the Payne effect measured for various elastomeric compositions prepared according to the teachings of the present disclosure using process parameters of Run 3-02;

FIG. 14C is a bar chart for the Payne effect measured for various elastomeric compositions prepared according to the teachings of the present disclosure using process parameters of Run 3-03;

FIG. 14D is a bar chart for the Payne effect measured for various elastomeric compositions prepared according to the teachings of the present disclosure using process parameters of Run 3-04;

FIG. 15 is a graphical representation of the Payne effect measured for elastomeric materials vulcanized from elastomeric compositions prepared according to the teachings of the present disclosure plotted as a function of silanization time; and

FIG. 16 is a graphical representation of the loss factor (tan d) plotted as a function of mixing time for various elastomeric materials prepared according to the teachings of the present disclosure.

### DETAILED DESCRIPTION

The following description is merely exemplary in nature and is in no way intended to limit the present disclosure or its application or uses. It should be understood that throughout the description and drawings, corresponding reference numerals indicate like or corresponding parts and features.

In formulating an elastomeric composition, the elastomer or rubbery polymer is hydrophobic in nature, while the silica filler particles are very hydrophilic due to the presence of polar hydroxyl moieties. Thus combining silica fillers into an elastomeric polymer matrix to form an elastomeric composition is difficult because these polar fillers tend to agglomerate, i.e., via a hydrogen-bonding mechanism. This agglomeration leads to non-homogeneities in the elastomeric composition and contributes to the occurrence of hysteretic properties. These hysteretic properties can be reduced by minimizing the ability of the filler to hydrogen bond to itself. This can be accomplished by using a higher mixing temperature, allowing the mixing to proceed over a longer time in the presence of a silane coupling agent, or utilization of silica filler whose surface is homogeneously treated with a silane coupling agent.

The silanization of the silica surface may be enhanced by increasing the speed of reaction between the silane coupling agent and the silica filler. This conventionally is accomplished using high reaction temperatures or by controlling the extent of passivation via the control of the cross-sectional area of the coupling agent. In the present disclosure, another method of enhancing silanization is accomplished by the addition of activators or ultra-accelerators to the elastomeric composition during the initial mixing associated with the silanization reaction step. Conventionally, such accelerators are not added in the silanization step, but rather in the final step in which vulcanization takes place.

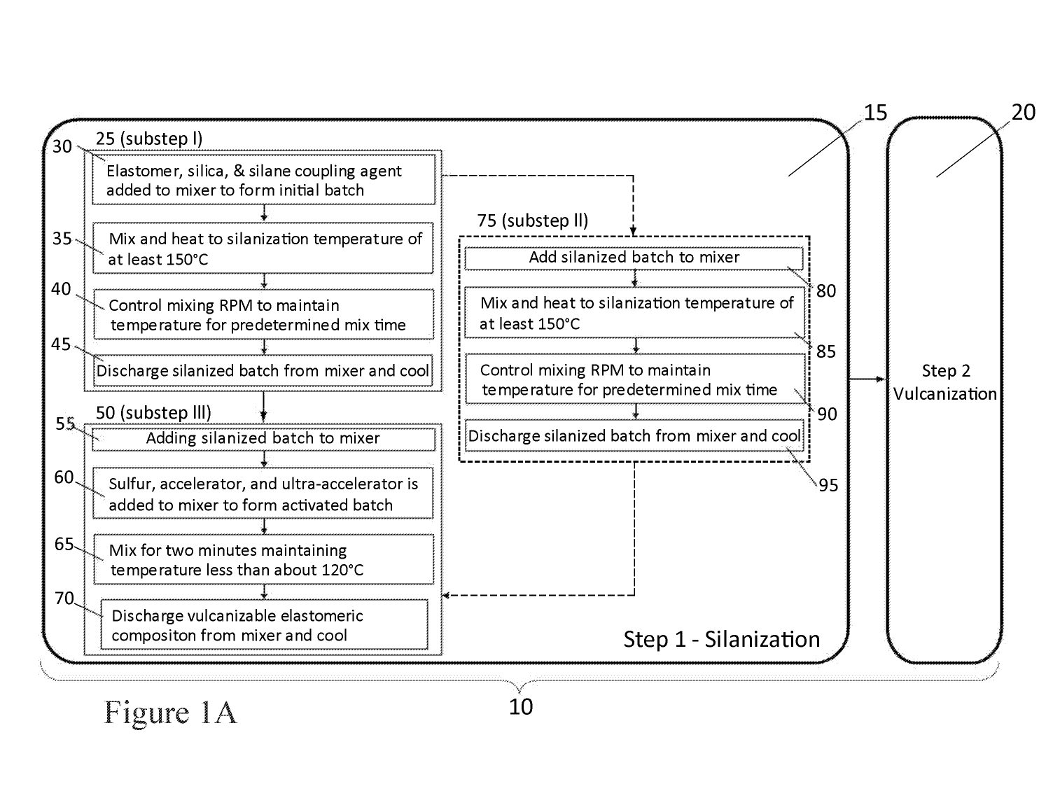

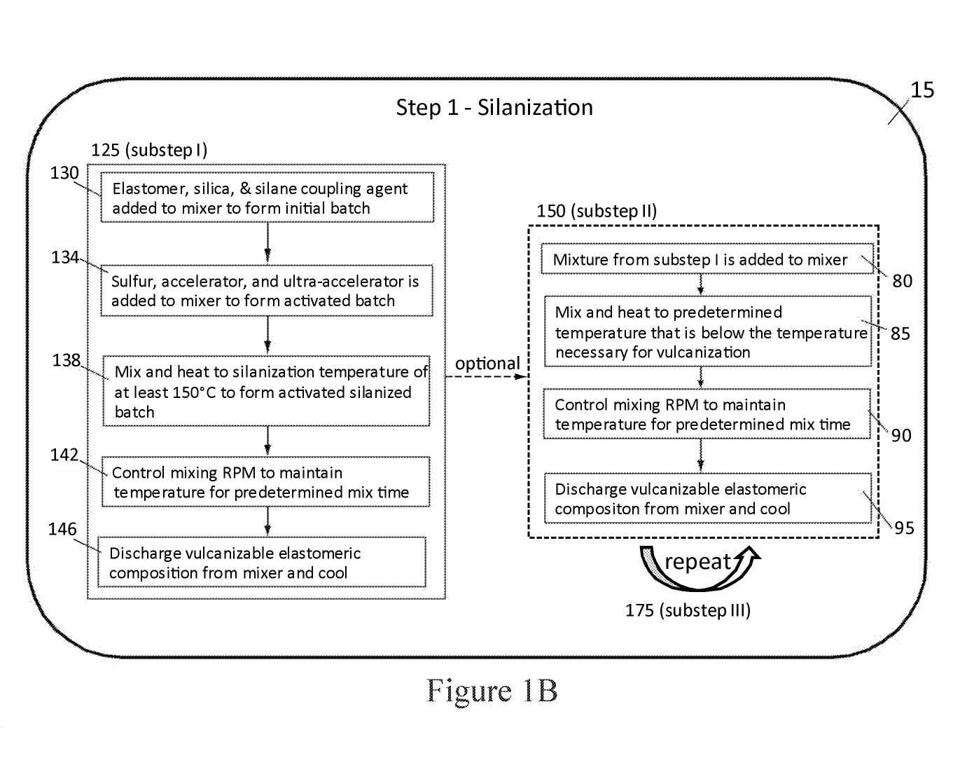

The present disclosure generally provides a method of forming a vulcanizable elastomeric composition as shown in FIG. 1. Similar to conventional processing, this method 10 comprises two process steps, namely, (1) silanization 15 and (2) vulcanization 20. However, according to the method 10 of the present disclosure, the silanization step 15 further comprises at least two substeps, namely, initial mixing 25 (substep I), and final mixing 50 (substep III). The initial mixing 25 substep I, includes combining 30 an elastomeric polymer matrix, a silica filler, and a silane coupling agent in predetermined amounts in a mixer to create an initial batch; mixing and heating 35 this initial batch to a temperature of at least 150° C. in order to cause the occurrence of a silanization reaction; maintaining 40 the occurrence of the silanization reaction for a predetermined amount of time, thereby, forming a silanized batch; and cooling 45 the silanized batch. The initial mixing 25 substep I is followed by the final mixing 50 substep III, which includes adding 55 the silanized batch to a mixer; adding 60 at least one of sulfur, an accelerator, and an ultra-accelerator in predetermined amounts to the silanized batch to create an activated batch; mixing and heating 65 the activated batch to less than about 120° C. for a predetermined amount of time to form a vulcanizable elastomeric composition; and cooling and discharging 70 the vulcanizable elastomeric composition from the mixer. The addition of sulfur, an accelerator, or an ultra-accelerator to the silanized batch enhances the overall efficiency of the surface passivation as compared to conventional processing. The addition of an ultra-accelerator is preferred. The mixing and heating of the initial batch and the activated batch may be done in a single mixer or in separate (first and second) mixers.

Optionally, the silanization step 15 according to another aspect of the present disclosure may further comprise another substep II of intermediate mixing 75. The intermediate mixing 75 substep II occurs after the initial mixing 25 substep I and prior to the final mixing 75 substep III. This intermediate mixing 75 substep II includes adding 80 the silanized batch to a mixer; mixing and heating 85 the silanized batch to a temperature of at least 150° C. in order to further cause the occurrence of a silanization reaction; maintaining 90 the occurrence of the silanization reaction for a predetermined amount of time; and cooling and discharging 95 the silanized batch. The intermediate mixing 75 substep II may be done in the same mixer or in a different mixer than the initial mixing 25 substep I and/or the final mixing 50 substep III. Preferably, the silanized batch is heated to a temperature in the range of about 160 to 165° C. (320 to 329° F.) in order to further cause the occurrence of the silanization reaction.

According to another embodiment of the present disclosure, the silanization step 15 may include a single mixing 125 substep I. This mixing 125 substep I, includes combining 130 an elastomeric polymer matrix, silica filler, and a silane coupling agent in predetermined amounts in a mixer to create an initial batch; adding 134 at least one of sulfur, an accelerator, and an ultra-accelerator in predetermined amounts to the initial batch to create an activated batch; adding mixing and heating 138 this activated batch to a temperature of at least 150° C. in order to cause the occurrence of a silanization reaction; maintaining 142 the occurrence of the silanization reaction for a predetermined amount of time by controlling the mixing, thereby, forming an activated silanized batch; and discharging 146 after cooling the vulcanizable elastomeric composition. The predetermined amount of sulfur, an accelerator, or an ultra-accelerator added to the initial batch is within the range of about 0.02 to 2.0 phr with between about 0.05 to 1.0 phr being preferred.

The mixing 125 substep I may optionally be followed by additional mixing 150 substep II, which includes adding 80 the vulcanizable elastomeric composition to a mixer; mixing and heating 85 the elastomeric composition to a predetermined temperature that is below the temperature necessary for vulcanization to occur; maintaining 142 the temperature established in the elastomeric composition by controlling the rate of mixing (RPM) for a predetermined amount of time; and discharging 95 the vulcanizable elastomeric composition after cooling. This additional mixing 150 substep II may optionally be repeated as mixing 175 substep III. The initial mixing 125 substep I and the optional additional mixing 150, 175 substeps II & III may be done in a single mixer or in separate mixers.

During the formation of the elastomeric composition in the silanization step 15, several process variables are capable of affecting the incorporation, dispersion, and distribution of the silica filler into the polymer matrix. For example, the ability to control the silanization reaction that occurs during the initial mixing of the silica-filler and silane coupling agent in the elastomeric polymer matrix is important to ensure that the resulting elastomeric composition exhibits the desired properties. More specifically, the rate at which the silane coupling agent is transported to the surface of the silica is known to be capable of competing with the occurrence of the silanization reaction as the rate determining step in the process. Thus the geometry of the mixing chamber, the type of rotors, and the amount of shear induced by the mixing action, as well as the polarity and size of the coupling agent are important parameters to consider. Any agglomeration of the silica filler prior to or during the initial mixing of the individual components can affect the overall performance of the resulting vulcanized elastomeric article formed from the elastomeric composition.

In conventional processing, the vulcanization reaction is allowed to occur after a vulcanizing agent or a mixture of vulcanizing agents are mixed with the elastomeric composition and the resulting mixture is heated to a vulcanization temperature in a mold under pressure. The end result of vulcanization is the formation of an elastomeric article, including but not limited to a tire, that contain multiple cross-links between polymer chains in the elastomeric matrix, as well as between the polymer chains and the surface-treated silica filler. Originally, vulcanization was accomplished by using elemental sulfur as the sole vulcanization agent at a concentration of about 8 parts per 100 parts of rubber (phr). The vulcanization reaction was typically carried out over a period of about 5 hours and at a temperature of at least 140° C. However, the addition of accelerators to the elastomeric composition and higher temperatures (e.g., about 170° C.) during the vulcanization step was found to lower the reaction time down from several hours to several minutes. Examples of conventional accelerators used with elemental sulfur during vulcanization include benzothiozoles, benzothiazolesulfenamides, dithiocarbamates, and amines.

The general reaction mechanism for conventional vulcanization is believed to include the reaction of the accelerator with sulfur to give monomeric polysulfides as depicted by R—Sₓ—R, where R represents an organic radical derived from the accelerator. These monomeric polysulfides, then interact with the elastomer to form polymeric polysufides, e.g., elastomer-Sₓ—R. Finally, the polymeric polysulfides react, either directly or through an intermediate to form crosslinks between elastomeric polymer chains, e.g., elastomer-Sₓ-elastomer. Increases in sulfur and/or accelerator concentrations can give rise to higher crosslink densities, which correlate with higher moduli, stiffness, and hardness.

The use of surface-treated silica fillers in various elastomeric compositions are known to enhance the performance of the elastomeric articles formed via the vulcanization of said elastomeric compositions. For example, in tires, the use of silica-filled elastomeric compositions can improve such performance characteristics as rolling resistance and wet/dry traction without sacrificing wear or abrasion resistance. However, these same silica-filled compositions are known to cause the elastomeric material obtained after vulcanization to exhibit a particular stress-strain behavior known by one skilled-in-the-art as either the Payne effect or the Fletcher-Gent effect. The magnitude of the Payne effect is considered to represent a measure of the filler-to-filler interactions present in the vulcanized elastomeric material. These interactions are influenced by the degree of filler networking or agglomeration that has occurred during the mixing of the elastomeric composition. The Payne effect plays an important role in understanding and defining the dynamic mechanical properties exhibited by the vulcanized, silica-filled elastomeric material that contribute to rolling resistance, hysteresis, and skid resistance.

The presence and magnitude of the Payne effect in an elastomeric material may be determined using a variety of standard test methods that utilize a dynamic mechanical analysis (DMA) instrument known to one skilled-in-the-art of rubber processing. The DMA instrument should be capable of subjecting a sample of the vulcanized elastomeric material to a range of deformation ratios (e.g., about 0.001% up to >100%) with high precision. One example of a standard test method that can be used includes ASTM D5992-96e1 (2006), entitled “Standard Guide for Dynamic Testing of Vulcanized Rubber and Rubber-Like Materials Using Vibratory Methods”, which is hereby incorporated by reference.

The Payne effect can be observed in elastomeric samples when placed under cyclic loading conditions that induce small strain amplitudes. The Payne effect represents a noticeable decrease in the viscoelastic storage modulus (G′) of filled elastomeric polymers when the amplitude of the applied small-strain oscillations is increased. More specifically, at approximately 0.1% strain amplitude, the storage modulus (G′) exhibited by the elastomeric material begins to decrease with increasing amplitude. At large strain amplitudes (e.g., greater than about 20%), the storage modulus (G′) of the elastomeric composition approaches its lower limit and the loss modulus (G″) of the elastomeric composition begins to approach a maximum. In essence, the Payne effect may be characterized as a stress softening effect, meaning that the elastomeric composition becomes softer under the application of high stress.

Changes in dynamic moduli of filled elastomers are traditionally associated with the aggregation of filler particles into clusters and networks. The occurrence of a large Payne effect is attributed to the disruption of the material's filler-filler network. Controlling the Payne effect is often desirable because it correlates with the frequency and amplitude-dependent dynamic stiffness and damping behavior of rubber bushings, automotive tires, and other elastomeric products.

In the present disclosure, the addition of sulfur, accelerators, or ultra-accelerators to the elastomeric composition during the silanzation process step 15 (i.e., before the vulcanization step 20) was unexpectedly found to reduce the Payne effect exhibited by vulcanized elastomeric materials formed from the elastomeric compositions prepared according to the teachings of the present disclosure. A total of eighteen (1-1 to 1-18) vulcanizable elastomeric compositions were prepared using a three substep mixing process for the silanizaton reaction step 15. The discharge temperature for each of the first two substeps (I and II) was set at 163° C. (325° F.). The composition was mixed to the temperature set point and held for two minutes prior to being cooled and discharged in each of these substeps. In the third substep (III), the composition was heated to a temperature of 120° C. (248° F.) over a mix time of about 90 seconds. The difference between the eighteen compositions was either (a) the type of accelerator incorporated into the composition at about 0.2 phr or (b) the step in which the ultra-accelerator was added to the mix as further described in Table 1. The first two runs represent a conventional control reaction in that diphenyl guanidine (DPG) in an amount of 2.0 phr was used as the accelerator additive.

TABLE 1

| | Run # 1-XX | Accelerator | Substep Added |
|---|---|---|---|
| XX = | 01 | DPG Control | I |
| | 02 | DPG Control | III |
| | 03 | TBzTD | I |
| | 04 | TiBTD | I |
| | 05 | TATD | I |
| | 06 | TMTD | I |
| | 07 | ZBEC | I |
| | 08 | TMTM | I |
| | 09 | TETD | I |
| | 10 | BDTCH | I |
| | 11 | TBzTD | III |
| | 12 | TiBTD | III |
| | 13 | TATD | III |
| | 14 | TMTD | III |
| | 15 | ZBEC | III |
| | 16 | TMTM | III |
| | 17 | TETD | III |
| | 18 | BDTCH | III |

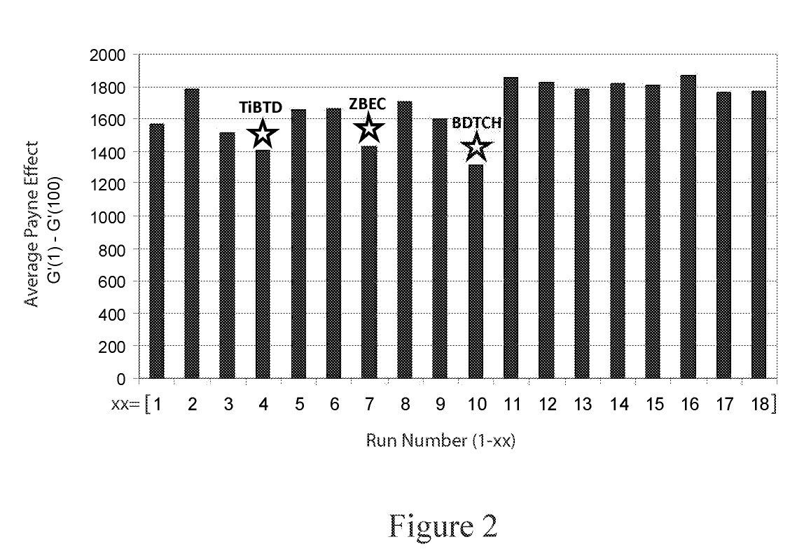

A sample of each of the 18 elastomeric compositions (runs 1-01 to 1-18) prepared according to the teachings of the present disclosure was vulcanized under similar conditions and tested using dynamic mechanical analysis. The Payne effect measured for each vulcanized elastomeric material is summarized in FIG. 2. The Payne effect represents the difference between the storage modulus (G′) measured for each sample at low strain, G′ (1% strain), and at high strain, G′ (100% strain).

The average Payne effect observed for each of the elastomeric materials (1-11 to 1-18) where the accelerator was added in the final mixing substep III was on the order of about 1800 dynes/cm². The Payne effect exhibited by the control run (1-02) where the DPG was added in the final mixing substep was also about 1800 dynes/cm². In the control run (1-01) where the DPG was added to the elastomeric composition during the initial mixing substep I, the resulting Payne effect was observed to be on the order of about 1600 dynes/cm². The addition of an ultra-accelerator to the elastomeric composition during substep I in runs 1-3, 1-4, 1-7, and 1-10 was found to reduce the Payne effect in comparison to the control run 1-01. The order in which the ultra-accelerator reduced the magnitude of the Payne effect was BDTCH (run 1-10)>TiBTD (run 1-04)˜ZBEC (run 1-07)>TBzTD (run 1-03). Thus, the addition of an ultra-accelerator in the first or initial mixing substep I reduces the Payne Effect as compared to adding the ultra-accelerator in a later mixing substep III.

In addition to the Payne effect, the viscosity exhibited by the elastomeric composition is another indicator that is known to be effective at predicting the performance characteristics exhibited by vulcanized elastomeric materials prepared using the elastomeric compositions. In fact, the efficiency of the silanization reaction may be evaluated using a combination of the viscosity exhibited by the elastomeric composition and the Payne effect exhibited by the resulting vulcanized elastomeric material.

One skilled-in-the-art will understand that the viscosity and other rheological properties exhibited by an elastomeric composition can be determined using a variety of standard rotational viscometry techniques or methods. An example of one such method for measuring viscosity, which is commonly used by the rubber industry, incorporates the use of a Mooney viscometer as described by ASTM D1646-07, entitled “Standard Test Methods for Rubber-Viscosity, Stress Relaxation, and Pre-Vulcanization Characteristics (Mooney Viscometer)”, incorporated herein by reference. The Mooney viscometer involves the measurement of torque required to rotate a rotor at constant speed in an elastomeric composition held at a constant temperature. The resulting viscosity measurement, termed Mooney viscosity, is thus actually a measure of the shearing torque averaged over a range of shearing rates. The measurement of Mooney viscosity may be used to study changes in the flow characteristics of the elastomeric composition that occur during the mixing or milling process.

Mooney viscosity is considered to be a measure of filler networking in an elastomeric composition. Thus the measured Mooney viscosity may be used as an effective indicator for the extent to which the surface of the silica filler is silanized. One skilled-in-the-art will understand that filler networking is a diffusion controlled process, where filler particles “diffuse” through the viscous polymer matrix to make contact with neighboring filler particles. Once the particles contact each other, agglomeration may occur due to hydrogen bonding, thereby, precluding particle separation. Agglomeration will occur in instances where the silanization of the filler's surface is absent or incomplete. When agglomeration occurs, the viscosity of the elastomeric composition will increase from its initial value to a value associated with the extent of filler association. The difference between the initial viscosity and the final viscosity is called the delta Mooney viscosity. A high resulting delta Mooney viscosity can correlate with a greater degree of difficulty in processing the composition.

A total of thirty six (2-1 to 2-36) vulcanizable elastomeric compositions were prepared using the previously described three mixing substeps for the silanization step 15 in the overall process or method 10. The difference between the thirty-six compositions was either (a) the type of ultra-accelerator incorporated into the composition at about 0.2 phr or (b) the substep in which the accelerator was added to the mix as further described in Table 2. The first four runs represent a conventional control reaction in that diphenyl guanidine (DPG) in an amount of 2.0 phr was used as the accelerator additive.

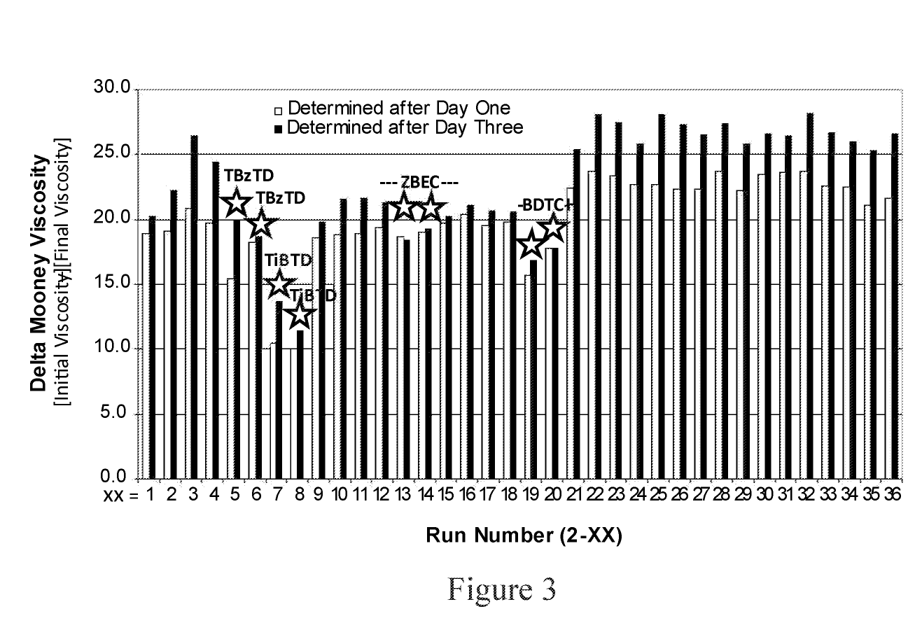

The delta Mooney viscosity for each of the thirty-six elastomeric compositions measured at the end of day 1 and day 3 are summarized in FIG. 3. Referring now to FIG. 3, the delta Mooney viscosity exhibited by the control runs (2-03 and 2-04) where the DPG was added in the final mixing substep III was on the order of 20 Pa-sec on day 1 and 25 Pa-sec on day 3. In the control runs (2-01 and 2-02) where the DPG was added to the elastomeric composition during the initial mixing substep I, the resulting delta Mooney viscosity observed on day 1 and day 3 was on the order of about 18 and 21 Pa-sec, respectively. The delta Mooney viscosity observed for each of the elastomeric compositions (2-21 to 2-36) where the accelerator was added in the final mixing substep III was about the same as the control runs (2-03 and 2-04). However, the addition of an ultra-accelerator to the elastomeric composition during substep I in runs 2-5-2-8, 2-13, 2-14, 2-19, and 2-20 was found to reduce the delta Mooney viscosity after day 1 and day 3 in comparison to the control runs 2-01 and 2-02. The order in which the ultra-accelerator reduced the magnitude of the delta Mooney viscosity was TiBTD (runs 2-07 & 2-08)>BDTCH (runs 2-19 & 2-20)>TBzTD (runs 2-05 & 2-06)˜ZBEC (runs 2-13 & 2-14). The delta Mooney viscosity for runs 2-07 and 2-08 that used TiBTD was on the order of 10 Pa-sec and 13 Pa-sec after day 1 and day 3, respectively. Thus, the addition of an ultra-accelerator in the first or initial mixing substep (e.g., step I) reduces the delta Mooney viscosity as compared to adding the accelerator in a later mixing substep (e.g., step III) or in the first substep I for the control runs with DPG (see 2-01 & 2-02).

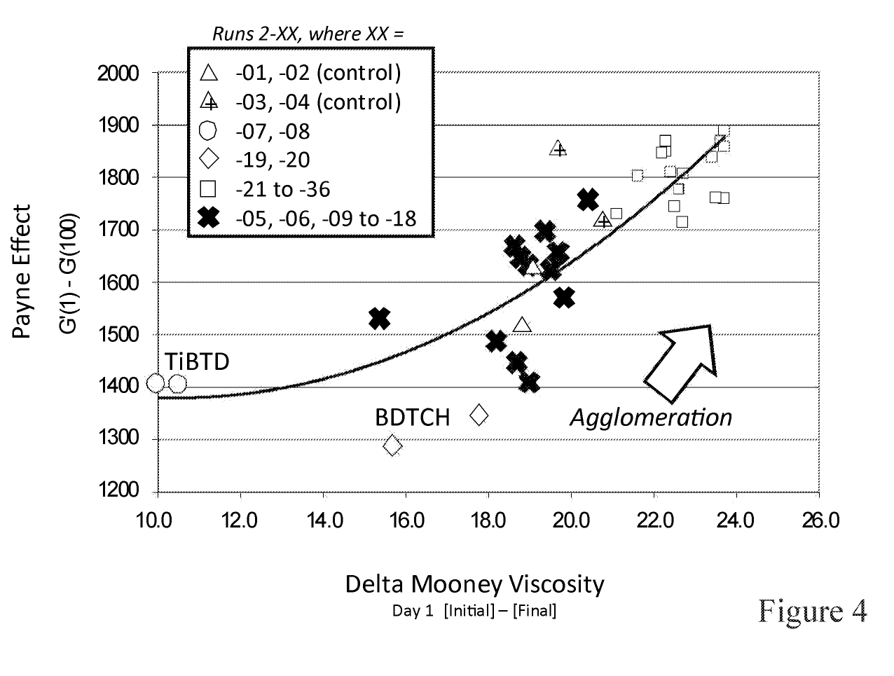

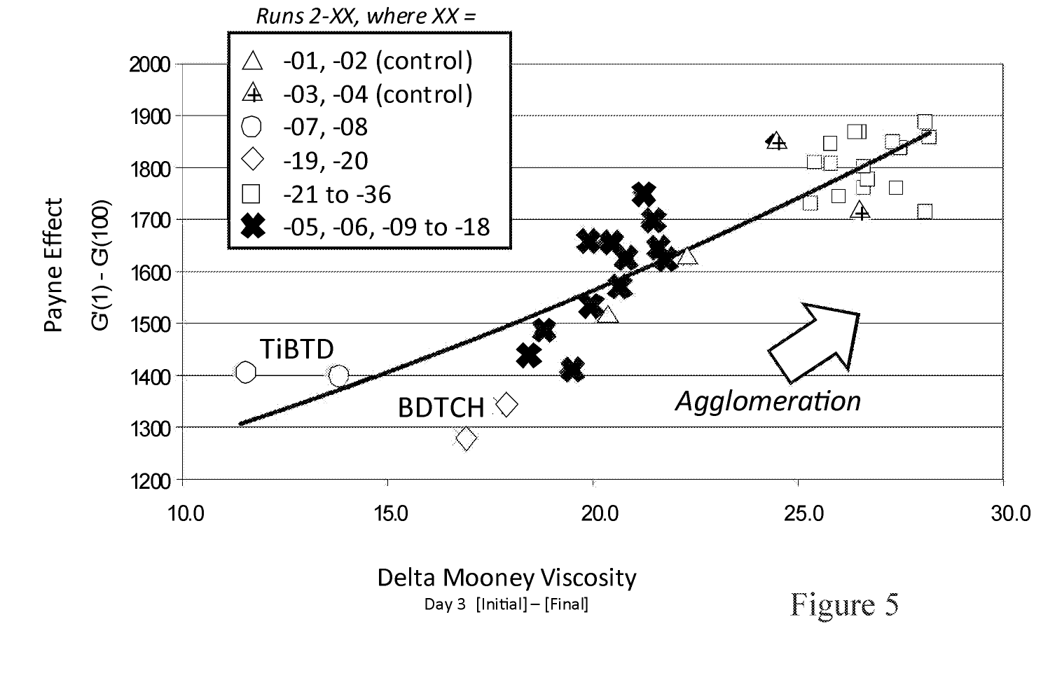

The overall kinetic effect of agglomeration of filler during the mixing substeps for the silanization step 15 can be determined upon correlating the measured delta Mooney viscosity with the measured Payne effect. This correlation is accomplished by plotting the Mooney viscosity after Day 1 and after Day 3 for each elastomeric composition as a function of the Payne Effect exhibited by the corresponding vulcanized elastomeric material formed from said elastomeric composition. A summary of the overall kinetic effect is provided in FIGS. 4 and 5.

TABLE 2

| | Run # 2-XX | Accelerator | Substep Added |
|---|---|---|---|
| XX = | -01 & -02 | DPG Control | I |
| | -03 & -04 | DPG Control | III |
| | -05 & -06 | TBzTD | I |
| | -07 & -08 | TiBTD | I |
| | -09 & -10 | TATD | I |
| | -11 & -12 | TMTD | I |
| | -13 & -14 | ZBEC | I |
| | -15 & -16 | TMTM | I |
| | -17 & -18 | TETD | I |
| | -19 & -20 | BDTCH | I |
| | -21 & -22 | TBzTD | III |
| | -23 & -24 | TiBTD | III |
| | -25 & -26 | TATD | III |
| | -27 & -28 | TMTD | III |
| | -29 & -30 | ZBEC | III |
| | -31 & -32 | TMTM | III |
| | -33 & -34 | TETD | III |
| | -35 & -36 | BDTCH | III |

Referring now to FIGS. 4 and 5, the higher the comparable values for the delta Mooney viscosity and corresponding Payne effect, the greater the amount of agglomeration and the more difficult the elastomeric composition will be to process. Many of the different accelerators (runs 2-05, 2-06, 2-09 to 2-18, 2-21 to 2-36) added either in mixing substep I or substep III are grouped in FIGS. 4 and 5 in approximately the same location as the control runs 2-01 to 2-04. The elastomeric compositions that include the addition of the either TiBTD (runs 2-07 & 2-08) or BDTCH (runs 2-19 & 2-20) in the initial mixing substep I exhibit a lower amount of agglomeration as shown by a delta Mooney viscosity and Payne effect that is lower than the delta Mooney viscosity and Payne effect exhibited by elastomeric compositions comprising any of the other accelerators or the control compositions. In FIG. 5, it becomes even more apparent than in FIG. 4 that the addition of the DPG or an ultra-accelerator in the initial mixing substep I (runs 2-01, 2-02, 2-05, 2-06, and 2-09 to 2-18) results in a lower amount of agglomeration as compared to the same addition made in a later mixing substep III (runs 2-03, 2-04, 2-21 to 2-36).

The affect that adding sulfur, an accelerator, or an ultra-accelerator to the elastomeric composition during the silanization step 15 has on the abrasion resistance exhibited by the resulting vulcanized elastomeric materials was examined. Multiple elastomeric compositions were prepared using a silanization step 15 comprised of the three mixing substeps as previously described. The sulfur and ultra-accelerator were added to the silanized batch in the final mixing substep III for each of these elastomeric compositions. The control runs performed for this study included the identical three mixing substeps, except that no accelerator was added during the final mixing substep III.

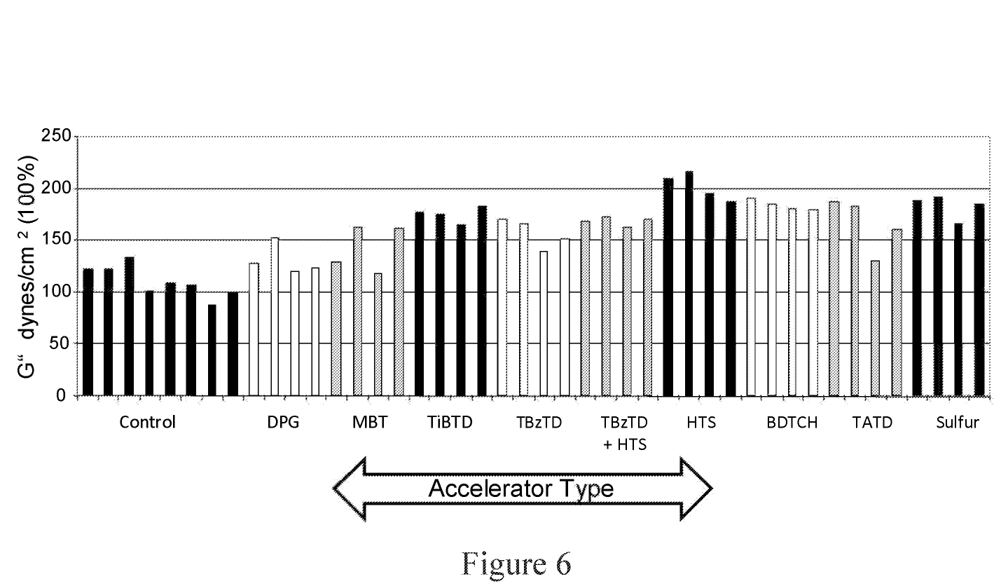

The loss modulus, G″ at high strain (i100° A strain) exhibited by an elastomeric composition is known to one skilled-in-the-art to be a good indicator of abrasion resistance. In FIG. 6, the loss modulus (G″) measured for each of the elastomeric compositions is summarized. The loss modulus exhibited by each of the elastomeric compositions was similar to the loss modulus exhibited by the control run, as well as the addition of DPG. The loss modulus measured for each run was in the range of about 100 dynes/cm² to about 150 dynes/cm². In this example, the addition of an accelerator or ultra-accelerator to the silanized batch during the final mixing substep III in the silanization step 15 did not affect the abrasion resistance of the resulting elastomeric composition.

Abrasion resistance can be measured for elastomeric compositions by a variety of standard methods known to one skilled-in-the-art. An example of such a standard method is the Pico abrasion test as described in ASTM D2228-04E01, entitled “Standard Test Method for Rubber Property-Relative Abrasion Resistance by Pico Abrader Method”, which is hereby incorporated by reference. The Pico abrasion test basically uses rotating cutting knives to abrade a vulcanized elastomeric sample and compares the damage caused to the sample against a known or standardized reference sample. In this test, a higher Pico abrasion index value indicates better abrasion resistance.

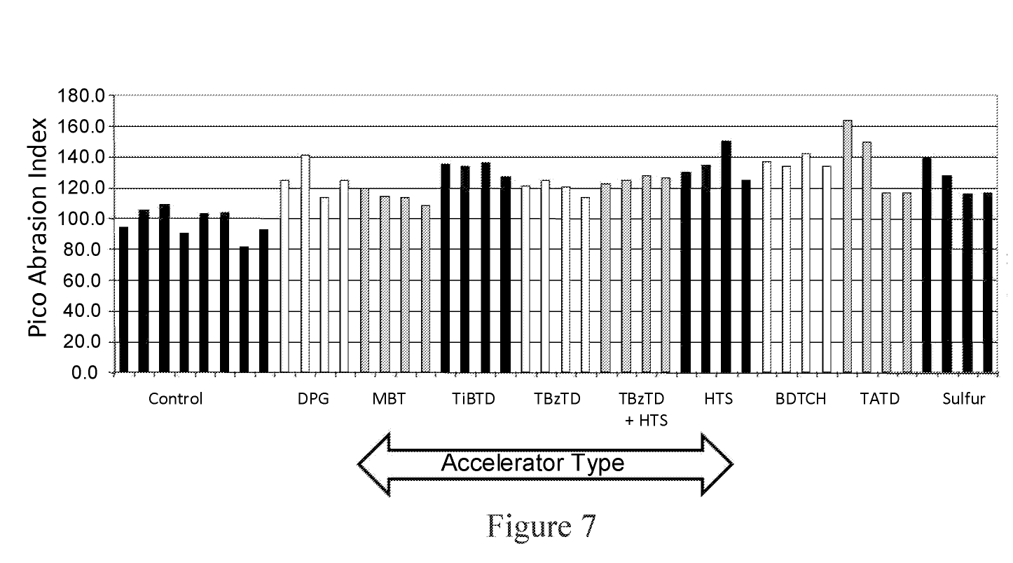

Each of the elastomeric compositions was subjected to the Pico abrasion test and the corresponding Pico abrasion index value measured. A summary of the Pico abrasion value obtained for each of the elastomeric compositions is provided in FIG. 7. The Pico abrasion index value exhibited by each of the elastomeric compositions was similar to or slightly higher than the Pico abrasion index value exhibited by the control run or the elastomer composition comprising the addition of DPG. Thus, the addition of an accelerator or ultra-accelerator in the final mixing substep III of the silanization step 15 in the overall process or method 10 maintains Pico abrasion resistance.

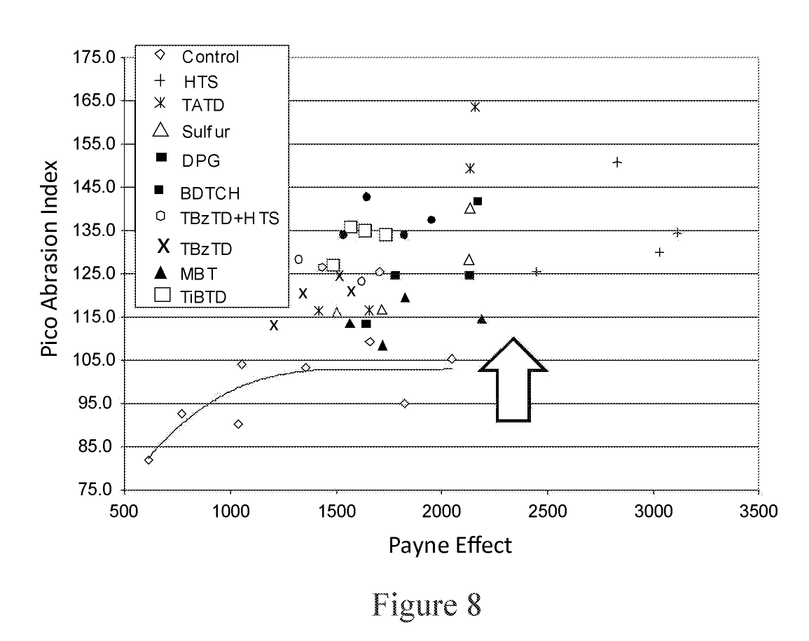

The Payne effect exhibited by each of the elastomeric compositions was measured. The Pico abrasion index for each elastomeric composition was then plotted as a function of the measured Payne effect as shown in FIG. 8. Referring to FIG. 8, the control runs exhibit a decrease in abrasion resistance with a decrease in the Payne effect. However, for a given Payne effect, the compositions that include an accelerator or ultra-accelerator added during the final mixing substep III exhibit a higher Pico abrasion index value or improved abrasion resistance.

In addition to abrasion resistance, another property of an elastomeric article (e.g., in tires) that is commonly evaluated is rolling resistance. Rolling resistance is known to one skilled-in-the-art to generally correlate with the loss factor (i.e., loss tangent or tan delta) measured at 60° C. for a vulcanized elastomeric material during dynamic mechanical analysis (DMA). The loss factor represents the ratio of the loss modulus (G″) and the storage modulus (G′) as measured for the elastomeric material. The loss factor (tan d) was determined for each of the elastomeric materials over the strain range of 1% to 25%.

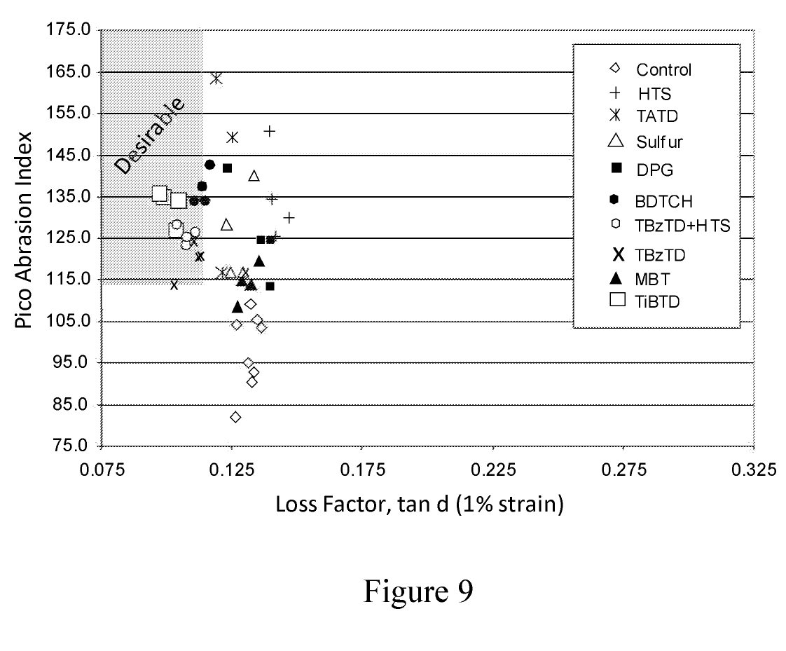

In FIG. 9, the Pico abrasion index value for each elastomeric material is plotted as a function of the loss factor determined for the material upon the application of low strain (1%). Referring to FIG. 9, the elastomeric materials of the present disclosure derived from elastomeric compositions that include an ultra-accelerator added during the silanization step 15 exhibit a reduction in the loss factor at low strain level of about 10 to 35%. In addition, the Pico abrasion resistance is improved for the elastomeric materials of the present disclosure compared to the control runs by about 15 to 50%. The best case, where both tan delta and Pico abrasion resistance is improved or enhanced, are observed to occur when TiBTD, TBzTD, (TBzTD+Duralink® HTS), or BDTCH is used as the ultra-accelerator. Since the elastomeric compositions including these ultra-accelerators at low strain exhibit a decreased amount of hysteretic behavior, the elastomeric materials prepared using these compositions are expected to exhibit lower rolling resistance and tire deformations (about 2-10%).

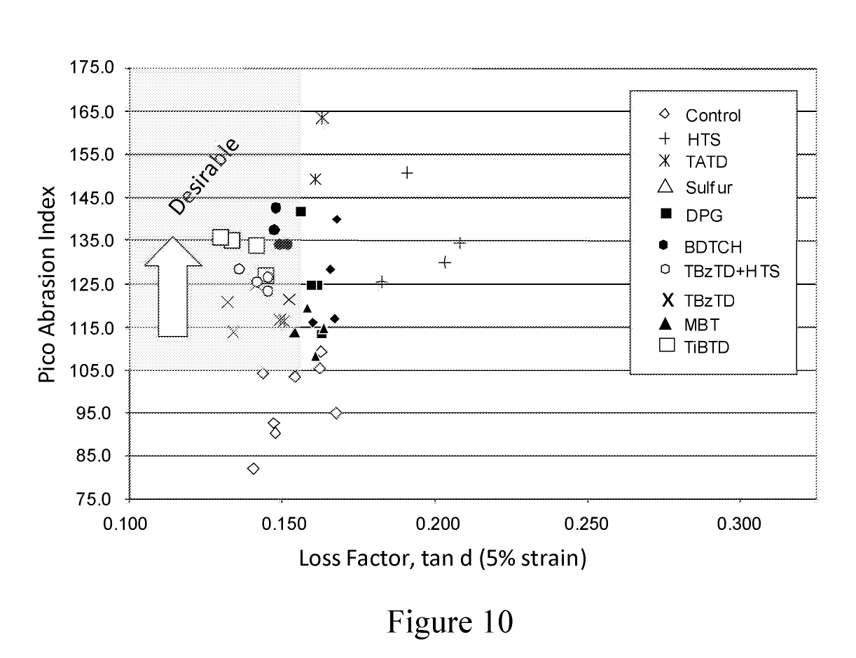

In FIG. 10, the Pico abrasion index value for each elastomeric material is plotted as a function of the loss factor determined for the material upon the application of moderate strain (5%). Referring to FIG. 10, the benefit of reducing the loss factor (tan d) upon the addition of an ultra-accelerator during the initial mixing in the silanization step begins to diminish. However, the Pico abrasion index value remains enhanced for compositions that comprise an ultra-accelerator. In addition, an improved or enhanced loss factor can still be observed for compositions that include TiBTD, TBzTD, and (TBzTD+Duralink® HTS) as the ultra-accelerator of choice.

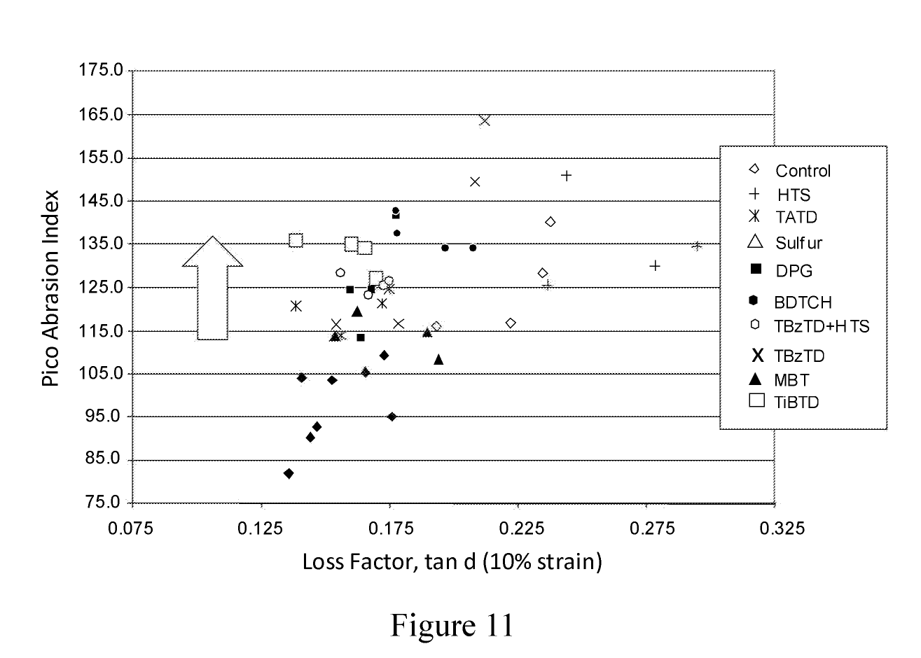

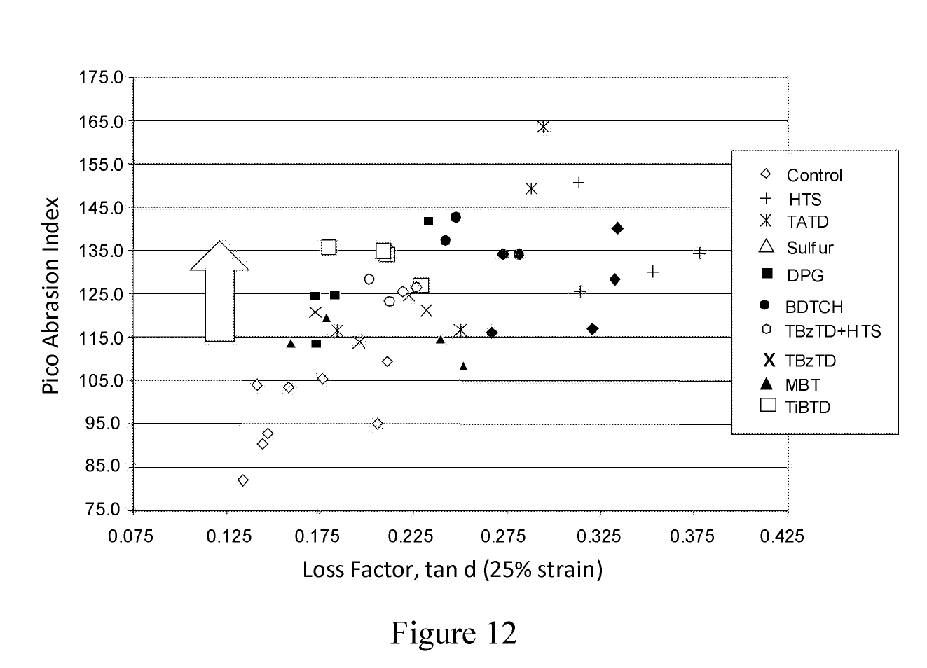

In FIGS. 11 and 12, the Pico abrasion index value for each elastomeric material is plotted as a function of the loss factor (tan d) determined for the material upon the application of a relatively high strain of 10% and high strain of 25%, respectively. Referring to FIG. 11, the benefit associated with a reduction in the loss factor for elastomeric compositions that include the addition of an ultra-accelerator during the silanization reaction step 15 is diminished upon reaching a strain level of 10%. However, even at this strain level (10%), each elastomeric material that includes an ultra-accelerator exhibits an enhancement in the corresponding Pico abrasion index value.

Referring now to FIG. 12, upon a further increase in the level of strain to 25%, the elastomeric compositions begin to exhibit hysteretic behavior. This hysteresis at high strains supports the “dissipative energy” mechanism believed to be associated with improved durability. However, even at a high strain level of 25%, an enhanced Pico abrasion index value is still observed for elastomeric compositions in which an ultra-accelerator was added during the silanization reaction step 15.

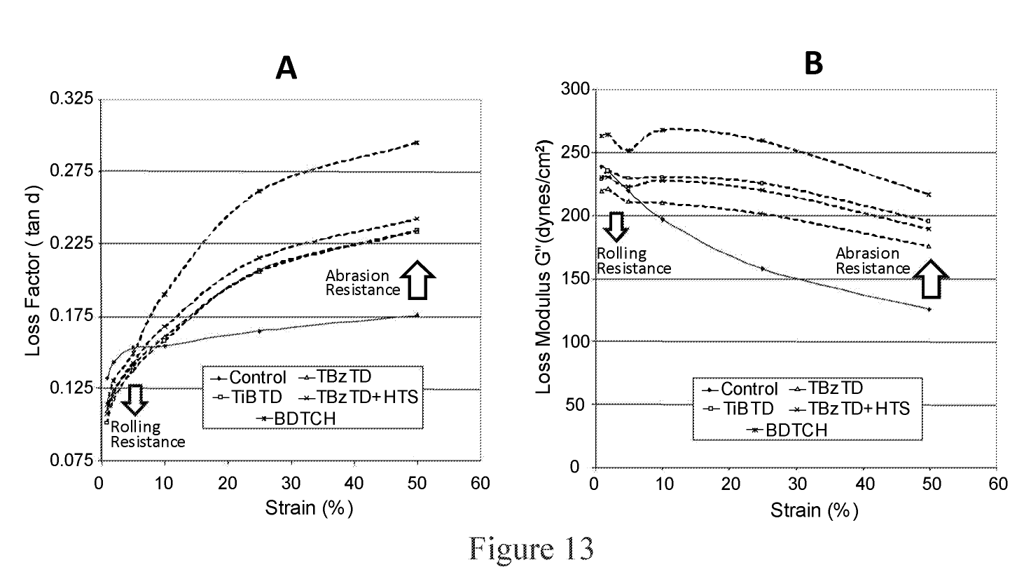

The relative and absolute energy dissipation for the elastomeric compositions can be examined by plotting the loss factor (tan d) and the loss modulus (G″), respectively, as a function of strain level as shown in FIGS. 13A and 13B. At a low level of strain, the lower loss factor values exhibited by the elastomeric compositions of the present disclosure as compared to the control compositions tend to demonstrate lower rolling resistance (FIG. 13A). The benefit associated with incorporating the various accelerators or ultra-accelerators in the elastomeric composition during the silanization step 15 manifests itself in the lowering of the loss factor exhibited by the elastomeric material at low strain levels. The usefulness of the ultra-accelerators in achieving this benefit follows the order TiBTD>(TBzTD+HTS)˜TBzTD>BDTCH>Control. Similarly, a lower loss modulus at low strain level also indicates a lower rolling resistance for the elastomeric compositions of the present disclosure (see FIG. 13B). The benefit associated with the various ultra-accelerators with respect to lowering the loss modulus at low strain follows the order TBzTD>TBzTD+HTD˜TiBTD>Control>BDTCH.

Rolling resistance, which is also known as rolling friction or drag, refers to the resistance that occurs when an object, such as a tire, rolls on a flat surface, such as a road. A low rolling resistance is desirable because minimization of the energy dissipated as heat when a vehicle's tires travel along a road enhances the fuel efficiency exhibited by the vehicle. Although elastomeric materials whose measured viscoelastic properties include a hysteresis or damping factor may exhibit better tear, fatigue and abrasion resistance qualities, these same materials may lead to poorer fuel economy due to higher rolling resistance. A more thorough discussion of the various factors that affect the fatigue life of rubber is provided by W. Mars and A. Fatemi in an article published in Rubber Chemical Technology (RCT), vol. 77(3), pgs 392-412 (2002), the entire contents of which are hereby incorporated by reference.

Typical deformations of the tread elements of a tire occur during normal operation or revolution of the tire on a highway at about 1-10% strain. However, failure events associated with crack growth or tearing induced by fatigue or abrasion occur at strains that are of a greater magnitude, such as greater than 25% and often at 100% or greater. A correlation between the loss modulus and abrasion resistance exhibited by an elastomeric material is possible in light of its strain dependence as shown in FIGS. 13A and 13B. Rolling resistance and abrasion resistance can be simultaneously improved for elastomeric materials prepared using the elastomeric compositions of the present disclosure by reducing the exhibited loss factor (tan d) at low strain (FIG. 13A), while increasing the associated loss modulus at high strain (FIG. 13B). Various mechanisms of energy dissipation provide a rational basis for this affect. A more thorough discussion of these mechanisms is provided in an article published by F. Ignatz-Hoover at the Fall ACS Meeting, Rubber Division, Oct. 5-8 (2004), Columbus, Ohio, the entire contents of which are hereby incorporated by reference.

At a high level of strain, the higher loss factor (see FIG. 13A) and higher loss modulus (see FIG. 13B) exhibited by the elastomeric compositions of the present disclosure indicate higher or enhanced abrasion resistance as compared to the control composition. The enhancement obtained for the different ultra-accelerators added during the initial silanization reaction 15 follows the order of BDTCH>(TBzTD+Duralink® HTS)>TBzTD˜TiBTD>>Control with respect to the loss factor and BDTCH>TiBTD>(TBzTD+Duralink® HTS)>TBzTD>>Control with respect to the loss modulus. The elastomeric compositions of the present disclosure benefit from reduced mixing times that may correlate with an increase in productivity (e.g., about a 30 to 60% reduced cycle time). In addition, the resulting elastomeric article will also benefit from having a lower rolling resistance and an improvement in abrasion resistance over articles manufactured using conventional process methodology.

Although not wanting to be bound by any theory, several explanations exist for the observed phenomenon. One possible explanation is that the addition of an accelerator or an ultra-accelerator to the elastomeric composition during the silanization step of the process induces a small amount of the silane coupling agent to couple with the elastomeric polymer (e.g., form “bound” rubber) prior to the vulcanization step. Another possible explanation is that the addition of the ultra-accelerator to the elastomeric composition during the mixing substeps not only enhances the silanization reaction, but also induces a small amount of vulcanization to occur as well. Other theories or explanations may also be possible.

Another objective of the present disclosure is to provide a vulcanizable elastomeric composition that comprises an elastomeric polymer matrix, a silica filler, a silane coupling agent, sulfur, and an ultra-accelerator where the silane coupling agent is coupled to the silica filler through the occurrence of a silanization reaction and the ultra-accelerator enhances the efficiency of said silanization reaction and forms at least one bond with the elastomeric polymer matrix.

According to one aspect of the present disclosure, various ultra-accelerators and combinations of said ultra-accelerators may be used in the elastomeric compositions. The ultra-accelerators may include, but not be limited to, 1,6-bis(N,N-dibenzylthiocarbamoyldithio)-hexane (BDTCH, Vulcuren® KA9188, Lanxess Deutschland GmbH), tetrabenzylthiuram disulfide (TBzTD, Perkacit® TBzTD, Flexsys), tetraisobutylthiuram disulfide (TiBTD, Perkacit® TiBTD, Flexsys), zinc dibenzyldithiocarbamate (ZBEC, Perkacit® ZBEC, Flexsys), tetraethylthiuram disulfide (TETD, Perkacit® TETD, Flexsys), tetramethylthiuram disulfide (TMTD, Perkacit® TMTD, Flexsys), tetramethylthiuram monosulfide (TMTM), tetraalkyl (C₁₂-C₁₄) thiuram disulfide (TATD, Royalac® 150, Uniroyal Chemical Company), hexamethylene-1,6-bis(thiosulfate) disodium salt dihydrate (HTS, Duralink® HTS, Flexsys), and mixtures thereof. Preferably, the ultra-accelerator is BDTCH, TBzTD, or TiBTD, or a mixture of one of these three preferred ultra-accelerators and at least one other accelerator. Although the ultra-accelerators may be added to the elastomeric composition in any amount necessary to achieve the desired properties, an amount in the range of about 0.05 phr to 1.0 phr is preferred.

Any silane coupling agent with one end capable of coupling to the surface of the silica filler and a second end capable of coupling with the elastomeric polymer matrix may be used in the silanization step according to the method of the present disclosure. Suitable elastomer-reactive end-groups of the coupling agent include, but are not limited to, one or more of mercapto, amino, vinyl, epoxy, and sulfur groups. Examples of such coupling agents include, but are not limited to, 3,3′-bis(tri-ethoxysilylpropyl)disulfide, 3,3-bis(triethoxysilylpropyl)tetrasulfide, 2,2′-bis(triethoxysilyl-ethyl)tetrasulfide, 3,3′-bis(triethoxysilylpropyl)triasulfide, 2,2′-bis(dimethylmethoxysilyl-ethyl)disulfide, 3,3′-bis(methylbutylethoxysilylpropyl)tetrasulfide, 2,2′-bis(phenylmethyl-methoxysilylethyl)trisulfide, 3,3′-bis(dimethylethylmercaptosilylpropyl)tetrasulfide, 4,4′-bis(trimethoxysilylbutyl)tetrasulfide, 6,6′-bis(triethoxysilylhexyl)tetrasulfide, 12,12′-bis(triisopropoxysilyldodecyl)disulfide, 18,18′-bis(trimethoxysilyloctadecyl)tetrasulfide, 3,3′-bis(dimethoxyphenylsilyl-2-methylpropyl)disulfide, and the like. Preferred coupling agents for use herein are bis(triethoxysilylpropyl)polysulfide (Si-69®, Evonik Industries) and 3-(triethoxysilyl)propanthiol reaction products with ethoxylated C₁₋₃-alcohol (VP Si-363, Evonik Industries).

The elastomeric polymer matrix for use herein is based on highly unsaturated rubbers such as, for example, natural or synthetic rubbers, or mixtures thereof. Preferably, natural rubbers are used when forming truck tires. Representative highly unsaturated polymers that can be used herein include, but are not limited to diene rubbers, which are based on conjugated dienes such as 1,3-butadiene, 2-methyl-1,3-butadiene, 1,3-pentadiene, 2,3-dimethyl-1,3-butadiene, and the like, as well as copolymers of such conjugated dienes with monomers such as, styrene, alpha-methylstyrene, acetylene, e.g., vinyl acetylene, acrylonitrile, methacrylonitrile, methyl acrylate, ethyl acrylate, methyl methacrylate, ethyl methacrylate, vinyl acetate, and the like. Preferred highly unsaturated rubbers include natural rubber, cis-polyisoprene, polybutadiene, poly(styrene-butadiene), styrene-isoprene copolymers, isoprene-butadiene copolymers, styrene-isoprene-butadiene tripolymers, polychloroprene, chloro-isobutene-isoprene, nitrile-chloroprene, styrene-chloroprene, and poly (acrylonitrile-butadiene). In addition, mixtures of highly unsaturated rubbers with elastomers having a lower degree of unsaturation, such as EPDM, EPR, and butyl or halogenated butyl rubbers may also be utilized.

The silica filler may be of any type that is known to be useful in connection with the reinforcement of rubber compositions. Examples of suitable silica fillers include, but are not limited to, silica, precipitated silica, amorphous silica, vitreous silica, fumed silica, fused silica, synthetic silicates such as aluminum silicates, alkaline earth metal silicates (e.g., magnesium silicate and calcium silicate), natural silicates (e.g., kaolin), and any other naturally occurring silica and the like. One skilled-in-the-art will understand that a second reinforcing filler can also be used in addition to silica filler in the composition of the elastomeric composition without departing from the scope of the present disclosure. Such a second filler type, may include but not be limited to, carbon black, clay, ground or precipitated calcium carbonate, titanium dioxide, zinc oxide, and mixtures thereof.

The silica filler, silane coupling agent, elastomeric polymer matrix, and ultra-accelerator may be combined and mixed using any type of mixing apparatus known to one skilled-in-the-art. Examples of such mixers include tangential rotor type kneaders, intermeshing rotor type kneaders, mixing mills, Banbury mixers, and a Brabender Plasticorder, among others.

The following specific examples are given to further illustrate the invention and should not be construed to limit the scope of the invention.

### Example 1

### Effect of Mixing Variables on Payne Effect

Several mixing experiments were conducted according to the process variables described in Table 3. Each of the mixing experiments (runs 3-01 to 3-04) was selected to evaluate specific process variables that could dramatically affect overall productivity. In each of these experimental runs, silica filler treated with Si-69® coupling agent (Evonik Industries) was used for dispersion in an elastomeric polymer matrix. The process parameters of run 3-01 were selected in order to evaluate the effect that a moderately high mixing temperature may have on the Payne effect exhibited by an elastomeric material made from the resulting elastomeric composition. The utilization of a high mixing temperature can lead to lower production costs. However, a moderately high mixing temperature may also result in the need to use a longer mixing time, which could ultimately result in a sacrifice in overall productivity.

TABLE 3

| | Si-69 | Temperature | Time |
|---|---|---|---|
| Run # | (phr) | ° C. (° F.) | (minutes) |
| 3-01 | 4.0 | 154 (310) | 9.0 |
| 3-02 | 5.2 | 163 (325) | 6.3 |
| 3-03 | 5.2 | 141 (285) | 1.8 |
| 3-04 | 3.2 | 141 (285) | 3.2 |

The process parameters of run 3-02 were selected to determine if the use of a higher mixing temperature and a shorter mixing time could be used to favor productivity over production costs. However, in this scenario the end result could also be the need to use the Si-69 coupling agent (higher material cost), as well as an increase in the amount of scrap material generated resulting from a greater propensity to scorch the mixture during processing.

The process parameters associated with run 3-03, which use a moderate mixing temperature and short mix time, were selected because they could lead to a significant enhancement in productivity. However, in this scenario, an increase in the raw material cost also could result. In comparison with Run 3-01, the conditions in Run 3-03 have the potential to provide a productivity increase on the order of 500% and a silane cost increase of about 30%.

The effect of lowering the raw material cost was examined in Run 3-04, where the amount of the Si-69 coupling agent is reduced to 3.2 phr, while the processing temperature is maintained at 141° C. (285° F.), and the mixing time held at a practical level of 3.2 minutes. In comparison to Run 3-02, the conditions of Run 3-04 have the potential to decrease the silane cost by about 40%.

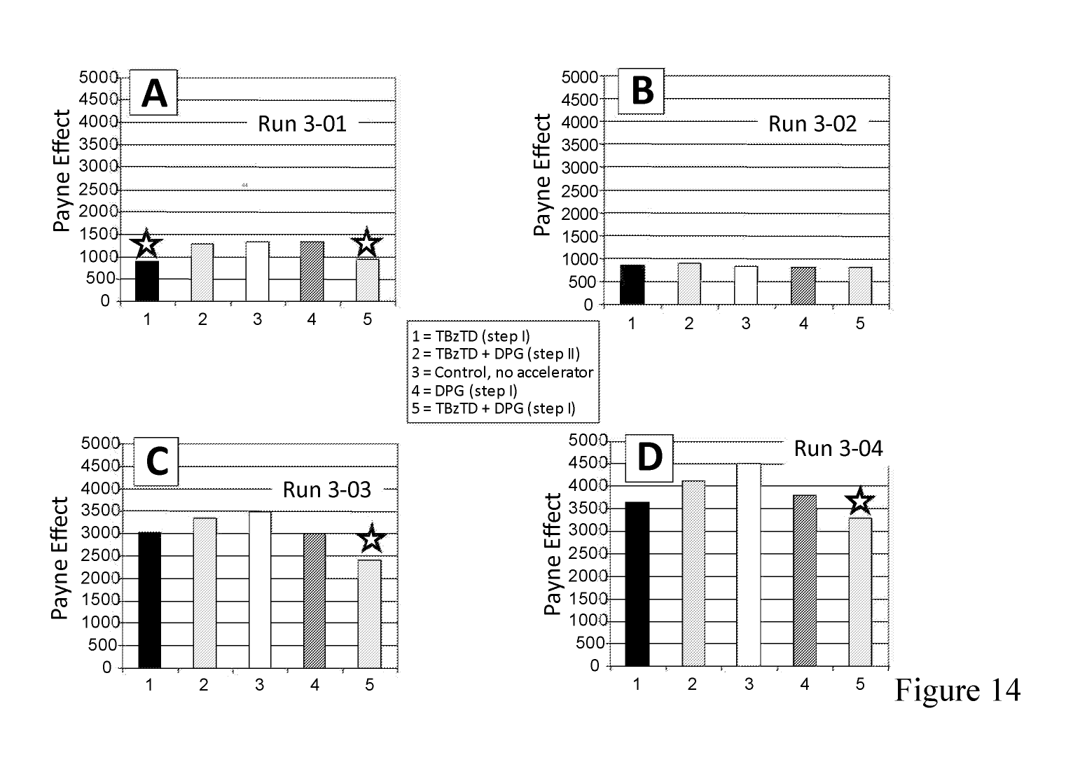

In each of the runs 3-01 to 3-04, the addition of an accelerator and/or ultra-accelerator in the initial mixing substeps I or II was done in order to enhance the efficiency of the silanization reaction according to the teachings of the present disclosure. In each of the runs several different accelerator and ultra-accelerator combinations were examined. In particular, TBzTD, DPG, a mixture of TBzTD & DPG were compared by adding them into the initial mixture (either substep I or II). Control reactions were also run in which no additives were added and where the TBzTD & DPG combination was added to the mixture in the final mixing substep (III). All elastomeric compositions were subsequently vulcanized under similar conditions and the properties exhibited by the vulcanized elastomeric materials evaluated. The Payne effect exhibited by the various elastomeric materials was measured as shown in FIGS. 14A to 14D.

Referring to FIG. 14A, the results of run 3-01 demonstrate a lower Payne effect for a vulcanized elastomeric material formed from an elastomeric composition where the ultra-accelerator, TBzTD, is added to the composition in the initial mixing substep I. This ultra-accelerator can be either added alone or as a mixture with another additive, such as a conventional accelerator, e.g., DPG. The results of run 3-02 as shown in FIG. 14B only show a marginal difference between the resulting Payne effect observed for each elastomeric material formed from an elastomeric composition comprising an accelerator and ultra-accelerator, as well as for the control (no additive) run.

Referring now to FIG. 14C, the results of run 3-03 indicate that the lowest Payne effect is observed for an elastomeric composition where a mixture of the ultra-accelerator, TBZTD is added along with the accelerator DPG in the initial mixing substep I. Similarly, the results of run 3-04 as shown in FIG. 14D, indicate a similar result. A comparison between the magnitude of the Payne effect observed in runs 3-01 to 3-04, indicate that a lower Payne effect will be observed when a higher mixing temperature is utilized (compare FIGS. 14A/B versus FIGS. 14C/D). This example demonstrates that the lowest Payne effect is observed when an ultra-accelerator is added in the initial mixing substep I along with a conventional accelerator, such as DPG. In addition, the use of a higher mixing temperature may be preferred.

### Example 2

### Quantitative Mix Time Improvement

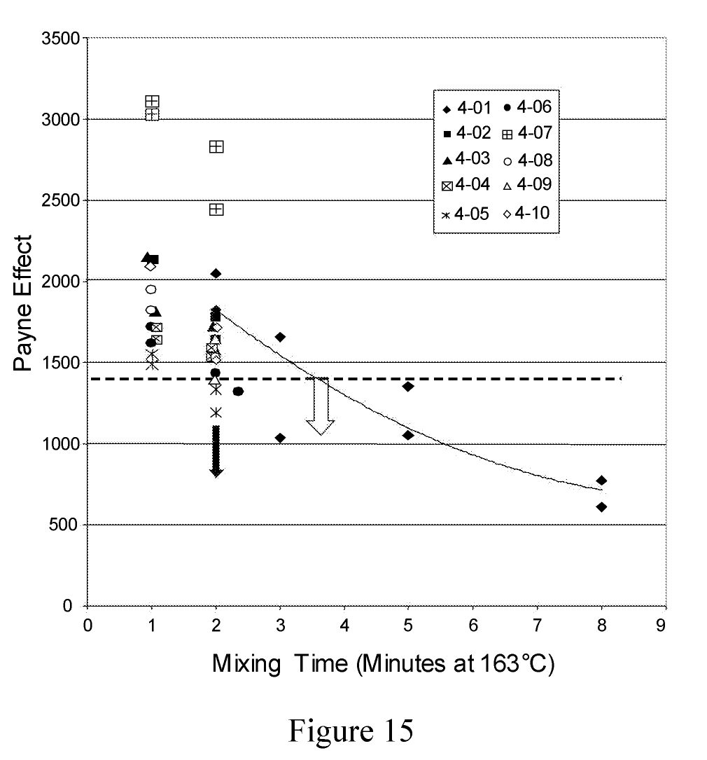

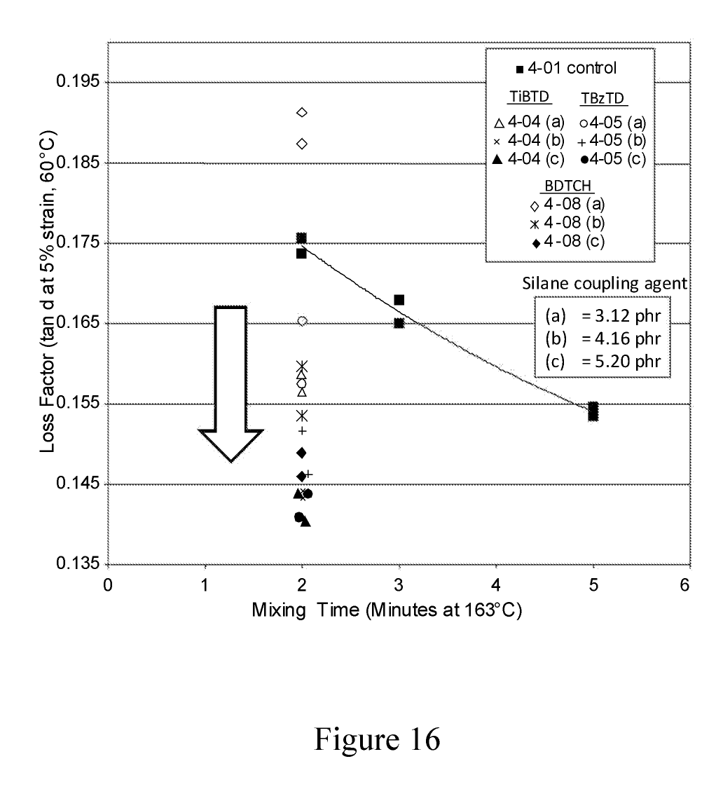

A total of ten different vulcanizable elastomeric compositions were prepared using the previously described three mixing substeps for the silanization step 15 in the overall process or method 10. The difference between the different compositions was the type of ultra-accelerator incorporated into the composition at about 0.2 phr as described in Table 4 for runs 4-01 to 4-10. In each run, multiple measurements were made relative to the Payne effect and loss factor (tan d at 5% strain) as shown in FIGS. 15 and 16, respectively. A control reaction (run 4-01) was included where no accelerator was utilized in the preparation of the elastomeric material. In addition, a conventional control reaction (run 4-02) was also conducted for comparison in which diphenyl guanidine (DPG) in an amount of 2.0 phr was used as the accelerator additive.

TABLE 4

| | Run # 4-XX | Accelerator |
|---|---|---|
| XX = | 01 | Control |
| | 02 | DPG |
| | 03 | MBT |
| | 04 | TiBTD |
| | 05 | TBzTD |
| | 06 | TBzTD + HTS |
| | 07 | HTS |
| | 08 | BDTCH |
| | 09 | ZDTP* |
| | 10 | Sulfur |

*= zinc o,o-dibutylphosphorodithioate, Vocol ® ZDTP, Flexys

The Payne effect exhibited by each elastomeric material was measured and plotted as a function of time the elastomeric composition was mixed at a temperature of 163° C. (325° F.). As shown in FIG. 15, the runs incorporating an accelerator (runs 4-02 to 4-10) reached the level of the Payne effect observed in the control run 4-01 in about half the time. In other words, the Payne effect observed for the control run (run 4-01) reached at about 3.6 minutes of mixing was reached by runs 4-02 to 4-10 that included an accelerator in about 1.9 minutes.

The loss factor exhibited by the elastomeric material prepared in the control run 4-01 and in runs 4-04, 4-05, and 4-08 was measured (at 60° C. and 5% strain) and plotted as a function of mixing time as shown in FIG. 16. Each of the runs 4-04, 4-05, and 4-08 was duplicated using different amounts of silane coupling agent (Si-69®, Evonik Industries). The amount of silane coupling agent utilized was either (a) 3.12 phr, (b) 4.16 phr, or (c) 5.20 phr. All of the runs, except for run 4-08(a) with the lowest amount of silane coupling agent was measured to have a lower loss factor at a mixing time of 2 minutes than the control run 4-01. In fact, the runs 4-04(a-c) and 4-05(a-c) utilizing TiBTD and TBzTD, respectively, exhibited a comparable or improved loss factor with about a 33-60% mixing time reduction. In addition, this mixing time reduction was possible for these runs (4-04 & 4-05) over the entire range (a-c) of silane coupling agent evaluated.

This example demonstrates that elastomeric materials can be prepared using elastomeric compositions of the present disclosure that will exhibit improved rolling resistance (e.g., correlates with lower loss factor) even when prepared using shorter mixing times and a lower amount of silane coupling agent.

A person skilled in the art will recognize that the measurements described are standard measurements that can be obtained by a variety of different test methods. The test methods described in the examples represents only one available method to obtain each of the required measurements.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. A method of forming a vulcanizable elastomeric composition, the method comprising the steps of;
combining an elastomeric polymer matrix, a silica filler, and a silane coupling agent in predetermined amounts in a mixer to create an initial batch;
mixing and heating the initial batch to a temperature of at least 150° C. in order to cause the occurrence of a silanization reaction;
maintaining the occurrence of the silanization reaction for a predetermined amount of time, thereby, forming a silanized batch;
cooling the silanized batch;
adding at least one of sulfur, an accelerator, and an ultra-accelerator in predetermined amounts to the silanized batch to create an activated batch;
mixing and heating the activated batch to less than about 120° C. for a predetermined amount of time to form a vulcanizable elastomeric composition; and
cooling and discharging the vulcanizable elastomeric composition from the mixer;
wherein the addition of the sulfur, accelerator, and ultra-accelerator enhances the efficiency of the silanization reaction.

2. The method of claim 1 wherein the step of maintaining the occurrence of the silanization reaction is accomplished by controlling the rate of mixing to ensure that the temperature stays at or above at least 150° C.

3. The method of claim 1, wherein the method further comprises the steps of:
adding the silanized batch to a mixer;
mixing and heating the silanized batch to a temperature to at least 150° C. in order to further cause the occurrence of a silanization reaction;
maintaining the occurrence of the silanization reaction for a predetermined amount of time; and
cooling and discharging the silanized batch prior to adding at least one of the sulfur, accelerator, and ultra-accelerator.

4. The method of claim 1, wherein the method further comprises the steps of:
discharging the cooled silanized batch from the mixer; and
charging a second mixer with the silanized batch;
wherein the steps of discharging the mixer and charging the second mixer are carried out prior to the step of adding at least one of the sulfur, accelerator, and ultra-accelerator to the silanized batch.

5. The method of claim 1, wherein the predetermined time associated with the step of mixing and heating the initial batch is less than about two minutes.

6. The method of claim 1, wherein during the step of mixing and heating the initial batch the temperature to which the initial batch is heated is in the range of about 160° C. to 165° C.

7. The method of claim 1, wherein the step of combining an elastomeric polymer matrix, a silica filler, and a silane coupling agent in a mixer uses a silane coupling agent having one end-group capable of coupling to the surface of the silica filler and a second end-group capable of coupling with the elastomeric polymer matrix, the second end-group being one selected from the group of a mercapto, amino, vinyl, epoxy, and sulfur group.

8. The method of claim 7, wherein the step of combining an elastomeric polymer matrix, a silica filler, and a silane coupling agent in a mixer uses bis(triethoxysilylpropyl)polysulfide or the 3-(triethoxysilyl)propanthiol reaction products with ethoxylated C13-alcohol as the silane coupling agent.

9. The method of claim 1, wherein the step of combining an elastomeric polymer matrix, silica filler, and a silane coupling agent in a mixer uses an elastomeric polymer selected from a natural rubber, a synthetic rubber, or mixtures thereof.

10. The method of claim 1, wherein the step of adding at least one of sulfur, an accelerator, and an ultra-accelerator to the silanized batch uses one selected from the group of 1,6-bis(N,N-dibenzylthiocarbamoyldithio)-hexane (BDTCH), tetrabenzylthiuram disulfide (TBzTD), tetraisobutylthiuram disulfide (TiBTD), and mixtures thereof.

11. The method of claim 10, wherein the step of adding at least one of sulfur, an accelerator, and an ultra-accelerator to the silanized batch further comprises at least a second accelerator selected as one from the group of zinc dibenzyldithiocarbamate (ZBEC), tetraethylthiuram disulfide (TETD), tetramethylthiuram disulfide (TMTD), tetramethylthiuram monosulfide (TMTM), tetraalkyl (C₁₂-C₁₄) thiuram disulfide (TATD), hexamethylene-1,6-bis(thiosulfate) disodium salt dihydrate (HTS), diphenyl guanidine (DPG), and mixtures thereof.

12. The method of claim 1, wherein in the step of adding sulfur, an accelerator, and an ultra-accelerator in predetermined amounts to the silanized batch, the ultra-accelerator is added in an amount in the range of about 0.02 phr to 5.0 phr.

13. A method of forming a vulcanizable elastomeric composition, the method comprising the steps of:
combining an elastomeric polymer matrix, a silica filler, and a silane coupling agent in predetermined amounts in a mixer to create an initial batch;
adding at least one of sulfur, an accelerator, and an ultra-accelerator in predetermined amounts to the initial batch to create an activated batch;
mixing and heating the initial batch to a temperature of at least 150° C. in order to cause the occurrence of a silanization reaction;
maintaining the occurrence of the silanization reaction for a predetermined amount of time, thereby, forming an activated silanized batch; and
cooling and discharging the activated silanized batch from the mixer as the vulcanizable elastomeric composition;
wherein the addition of the sulfur, accelerator, and ultra-accelerator enhances the efficiency of the silanization reaction.

14. The method of claim 13, wherein the method further comprises the steps of:
adding the vulcanizable elastomeric composition to a mixer;
mixing and heating the elastomeric composition to a predetermined temperature that is below the temperature necessary for vulcanization to occur;
maintaining the elastomeric composition at the predetermined temperature by controlling the rate of mixing (RPM) for predetermined mix time; and
discharging the vulcanizable elastomeric composition after cooling.

15. The method of claim 13, wherein the predetermined time associated with the step of mixing and heating the activated batch is less than about two minutes.

16. The method of claim 13, wherein during the step of mixing and heating the activated batch the temperature to which the activated batch is heated is in the range of about 160° C. to 165° C.

17. The method of claim 13, wherein the step of combining an elastomeric polymer matrix, a silica filler, and a silane coupling agent in a mixer uses a silane coupling agent having one end-group capable of coupling to the surface of the silica filler and a second end-group capable of coupling with the elastomeric polymer matrix, the second end-group being one selected from the group of a mercapto, amino, vinyl, epoxy, and sulfur group.

18. The method of claim 17, wherein the step of combining an elastomeric polymer matrix, a silica filler, and a silane coupling agent in a mixer uses bis(triethoxysilylpropyl)polysulfide or the 3-(triethoxysilyl)propanthiol reaction products with ethoxylated C13-alcohol as the silane coupling agent.

19. The method of claim 13, wherein the step of combining an elastomeric polymer matrix, a silica filler, and a silane coupling agent in a mixer uses an elastomeric polymer selected from a natural rubber, a synthetic rubber, or mixtures thereof.

20. The method of claim 13, wherein the step of adding at least one of sulfur, an accelerator, and an ultra-accelerator to the silanized batch uses one selected from the group of 1,6-bis(N,N-dibenzylthiocarbamoyldithio)-hexane, tetrabenzylthiuram disulfide (TBzTD), tetraisobutylthiuram disulfide (TiBTD), and mixtures thereof.

21. The method of claim 20, wherein the step of adding at least one of sulfur, an accelerator, and an ultra-accelerator to the silanized batch further comprises at least a second accelerator selected as one from the group of zinc dibenzyldithiocarbamate (ZBEC), tetraethylthiuram disulfide (TETD), tetramethylthiuram disulfide (TMTD), tetramethylthiuram monosulfide (TMTM), tetraalkyl (C₁₂-C₁₄) thiuram disulfide, hexamethylene-1,6-bis(thiosulfate) disodium salt dihydrate, diphenyl guanidine (DPG), and mixtures thereof.

22. The method of claim 13, wherein in the step of adding at least one of sulfur, and accelerator, and an ultra-accelerator in predetermined amounts to form an activated batch, the sulfur, accelerator, and ultra-accelerator is added in an amount in the range of about 0.02 phr to 5.0 phr.

23. A method of forming an elastomeric article for use as a tire, the method comprising the steps of:
forming a vulcanizable elastomeric composition according to claim 1 that comprises an elastomeric polymer matrix, a silica filler, a silane coupling agent, and at least one of sulfur, and accelerator, and an ultra-accelerator; and
subjecting the vulcanizable elastomeric composition to a predetermined temperature and pressure to form the elastomeric article;
wherein the applied temperature and pressure causes the elastomeric polymer matrix to cross-link and to couple with the silane coupling agent bound to the silica filler.

24. A method of forming an elastomeric article for use as a tire, the method comprising the steps of:
forming a vulcanizable elastomeric composition according to claim 13 that comprises an elastomeric polymer matrix, a silica filler, a silane coupling agent, and at least one of sulfur, an accelerator, and an ultra-accelerator; and
subjecting the vulcanizable elastomeric composition to a predetermined temperature and pressure to form the elastomeric article;
wherein the applied temperature and pressure causes the elastomeric polymer matrix to cross-link and to couple with the silane coupling agent bound to the silica filler.

25. A vulcanizable elastomeric composition for use in the formation of an elastomeric article via vulcanization, the elastomeric composition comprising:
an elastomeric polymer matrix;
silica filler;
a silane coupling agent having one end group capable of coupling to the surface of the silica filler and a second end group capable of coupling with the elastomeric polymer matrix; the second end-group being one selected from the group of a mercapto, amino, vinyl, epoxy, and sulfur group;
sulfur; and
at least one of sulfur, an accelerator, and an ultra-accelerator;
wherein the silane coupling agent is coupled to the silica filler through the occurrence of a silanization reaction;
wherein the sulfur, accelerator, and ultra-accelerator enhances the efficiency of the silanization reaction and the silane coupling agent forms at least one bond with the elastomeric polymer.

26. The elastomeric composition of claim 25, wherein the silane coupling agent is one selected from the group of bis(triethoxysilylpropyl)polysulfide and the 3-(triethoxysilyl)propanthiol reaction products with ethoxylated C13-alcohol.

27. The elastomeric composition of claim 25, wherein the elastomeric polymer matrix is one selected from a natural rubber, a synthetic rubber, or mixtures thereof.

28. The elastomeric composition of claim 25, wherein the accelerator or ultra-accelerator is one selected from the group of 1,6-bis(N,N-dibenzylthiocarbamoyldithio)-hexane (BDTCH), tetrabenzylthiuram disulfide (TBzTD), tetraisobutylthiuram disulfide (TiBTD), and mixtures thereof.

29. The elastomeric composition of claim 28, wherein the at least one of sulfur, accelerator and ultra-accelerator further comprises at least a second accelerator selected as one from the group of zinc dibenzyldithiocarbamate (ZBEC), tetraethylthiuram disulfide (TETD), tetramethylthiuram disulfide (TMTD), tetramethylthiuram monosulfide (TMTM), tetraalkyl (C₁₂-C₁₄) thiuram disulfide (TATD), hexamethylene-1,6-bis(thiosulfate) disodium salt dihydrate (HTS), diphenyl guanidine (DPG), and mixtures thereof.

30. The elastomeric composition of claim 25, wherein the sulfur, accelerator, and ultra-accelerator is present in an amount in the range of about 0.02 phr to 5.0 phr.

31. The method of claim 12, wherein in the step of adding sulfur, an accelerator, and an ultra-accelerator in predetermined amounts to the silanized batch, the sulfur, accelerator, and ultra-accelerator is added in an amount in the range of about 0.05 phr to 1.0 phr.

32. The method of claim 22, wherein in the step of adding sulfur, an accelerator, and an ultra-accelerator in predetermined amounts to the silanized batch, the sulfur, accelerator, and ultra-accelerator is added in an amount in the range of about 0.05 phr to 1.0 phr.

33. The elastomeric composition of claim 30, wherein the sulfur, accelerator, and ultra-accelerator is present in an amount in the range of about 0.05 phr to 1.0 phr.

34. The method of claim 1, wherein the step of combining an elastomeric polymer matrix, a silica filler, and a silane coupling agent in predetermined amounts in a mixer to create an initial batch may further comprise a second reinforcing filler;
wherein the second reinforcing filler is one selected from the group of carbon black, clay, ground or precipitated calcium carbonate, titanium dioxide, zinc oxide, and mixtures thereof.

35. The method of claim 13, wherein the step of combining an elastomeric polymer matrix, a silica filler, and a silane coupling agent in predetermined amounts in a mixer to create an initial batch may further comprise a second reinforcing filler;
wherein the second reinforcing filler is one selected from the group of carbon black, clay, ground or precipitated calcium carbonate, titanium dioxide, zinc oxide, and mixtures thereof.

36. The elastomeric composition of claim 25, wherein the elastomeric composition further comprises a second reinforcing filler selected as one from the group of carbon black, clay, ground or precipitated calcium carbonate, titanium dioxide, zinc oxide, and mixtures thereof.
